(19) United States
(12) Patent Application Publication
(10) Pub. No.: US 2008/0102414 A1
(43) Pub. Date: May 1, 2008

(54) POSTERIOR BITE RAMPS, KITS, AND METHODS OF USE TO CORRECT CLASS II AND/OR CLASS III MALOCCLUSIONS

(76) Inventors: Norbert Abels, Homburg (DE); Claus H. Backes, Saarbrucken (DE)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/553,909

(22) Filed: Oct. 27, 2006

(51) Int. Cl. A61C 3/00

(52) U.S. Cl. 433/19; 433/24

(57) ABSTRACT

A posterior bite ramp includes a tooth-attachment element and ramp element connected to the tooth-attachment element by a connection web. The tooth-attachment element is sized and configured for bonding to the lingual surface of a person's molar, behind the tooth, while the ramp element may be hingedly or bendably adjustable relative to the tooth-attachment element so as to form a ramp angle between the ramp element and an occlusal plane that is substantially perpendicular to the tooth-attachment element. The ramp element provides a ramp at a desired angle for engaging a corresponding molar of the opposite dental arch when the person's mouth is closed. The engagement between the ramp element and the corresponding molar of the opposite dental arch causes the lower jaw to move forward or backward relative to the upper jaw, thereby incrementally correcting a Class II or Class III malocclusion.

### BACKGROUND OF THE INVENTION

1. The Field of the Invention

The present invention is in the field of orthodontics, more particularly to apparatus and methods for the correction of class II and class III malocclusions.

2. The Relevant Technology

Orthodontics is a specialized field of dentistry that involves the application of mechanical forces to urge poorly positioned, or crooked, teeth into correct alignment and orientation. Orthodontic procedures can be used for cosmetic enhancement of teeth, as well as medically necessary movement of teeth or the jaw to correct underbites or overbites. For example, orthodontic treatment can improve the patient's occlusion so as to enhance spatial matching of corresponding teeth.

Class II and class II malocclusions occur when the upper and lower jaws are out of alignment. In a class II malocclusion, the upper jaw and teeth protrude relative to the lower jaw and teeth (i.e., the upper jaw is to far forward relative to the lower jaw). In a class III malocclusion, the lower jaw and teeth protrude relative to the upper jaw and teeth (i.e., the lower jaw is to far forward relative to the upper jaw. These conditions can result in difficulty in eating certain foods (e.g., pizza), increased wear of particular teeth, periodontal problems, increasingly visible gum tissue, and increased instances of the patient biting the roof of their mouth or the tongue. In addition, correction of class II or class III conditions results in a more aesthetically appealing smile for the patient.

Depending on the severity of the condition, correction can sometimes be achieved with installation and use of dental braces, although orthognathic surgery is often required for more serious cases because installation of dental braces can be ineffective in effecting sufficient movement of the jaw. Orthognathic surgery is expensive, invasive, and uncomfortable, especially from a patient's perspective. Therefore, there exists a need for devices and methods that can be used to provide less expensive, simpler, less invasive correction of these conditions.

### BRIEF SUMMARY OF THE PREFFERED EMBODIMENTS

The present invention is directed to posterior bite ramp devices and related kits and methods. The posterior bite ramp devices are configured for installation on upper and/or lower molars of an orthodontic patient. The posterior bite ramps include a substantially planar tooth-attachment element for bonding to the lingual surface of a person's molar, and a ramp element attached to the tooth-attachment element by a connection web, The ramp element is advantageously hingedly or bendably adjustable so as to allow the practitioner to adjust the connection web and ramp element to a desired treatment angle (e.g., by bending). In this way the adjustable posterior bite ramps are versatile, which advantageously allows for simple manufacture of posterior bite ramps which are adjustable, so that the practitioner can customize the treatment angle as necessary.

In a preferred embodiment, the bite ramp includes a substantially planar tooth-attachment element for bonding to the lingual surface of a person's molar, a first ramp element attached to the tooth-attachment element by a first connection web, and a second ramp element attached to the first ramp element by a second connection web. The ramp elements are adjustable so as to allow the practitioner to adjust the connection web and ramp elements to a desired treatment angle between a selected ramp element and the occlusal plane of the molar to which the tooth-attachment element is bonded.

The first ramp element and/or the second ramp element provide an angled ramp structure for engagement with the corresponding molar of an opposite dental arch so as to cause a disocclusion of a patient's dental arches upon closing of a patient's mouth. Once the ramp angle has been adjusted as desired by the practitioner, a curable resin composition or other locking means may be used to lock the first and/or second ramp element in a desired adjustment angle relative to the occlusal plane of the molar to which the tooth-attachment element is bonded.

Providing two ramp elements advantageously allows the practitioner to begin treatment with engagement between the molar of the opposite dental arch and the “higher” second ramp element, which provides for a greater degree of disocclusion between the molars and across the full dental arches because of the spaced apart relationship between the first and second ramp elements. Once treatment has made significant progress, the practitioner may remove (e.g., by cutting) the second ramp element and continue the treatment with engagement occurring between the molar of the opposite dental arch and the first ramp element, which provides only a limited degree of disocclusion (e.g., only the molars may be disoccluded), which is more comfortable for the patient, and can be used to complete treatment.

An alternative embodiment of a posterior bite ramp includes a first substantially planar tooth-attachment element for bonding to the lingual surface of a person's molar, at least one substantially planar ramp element attached to the tooth-attachment element by a connection web, and a second tooth-attachment element for bonding to the occlusal surface of a person's molar. The second tooth-attachment element is integrally connected to the ramp element by an integral interface such that the second tooth-attachment element extends occlusally from the ramp element. Similar to the earlier described embodiment, the connection web is hingedly and/or bendably adjustable so as to allow the practitioner to adjust the ramp element to a desired angle, after which it may be locked in place. Such an embodiment including first and second tooth-attachment elements advantageously allows for bonding the device to both the occlusal and lingual surfaces of the tooth, for additional bonding strength.

A related inventive kit includes a plurality of posterior bite ramps, which may include any of the embodiments described above, and a curable resin that may be used to attach the posterior bite ramps to a person's molars. The same or a different curable composition may be used to lock the adjustable posterior bite ramps in a desired ramp angle configuration. Such a kit advantageously allows an orthodontic practitioner to select, for example, two adjustable posterior bite ramps from the kit, and then adjust each of them to a desired ramp angle, after which the curable resin composition may be used to lock in the adjusted ramp angle and to attach the posterior bite ramps to selected molars of the upper or lower dental arch.

Alternatively, a kit may include a plurality of fixed angle bite ramps which are not adjustable, but in which the ramp element(s) are pre-fixed to a specific angle so as to provide a ramp structure. The kit advantageously provides a plurality of bite ramps at various different angles, so as to advantageously allow the practitioner to select, for example, two posterior bite ramps at a desired fixed angle, after which the curable resin composition is used to attach each of them to selected molars of the upper or lower dental arch. The posterior bite ramps and associated kits and methods have been found to advantageously allow a practitioner to correct both class II and class III malocclusions with only the use of orthodontics, i.e., without having to resort to invasive surgery.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary posterior bite ramp according to the present invention;

FIG. 2 is a perspective view of an alternative posterior bite ramp including two ramp elements;

FIG. 3 is a perspective view of an alternative posterior bite ramp including two tooth-attachment elements;

FIG. 4 illustrates an exemplary kit including a plurality of posterior bite ramps;

FIG. 5A illustrates a bonding resin being applied to the lingual surface of a person's first molar;

FIG. 5B illustrates the posterior bite ramp of FIG. 2 bonded to the lingual surface of the molar as prepared in FIG. 5A;

FIG. 5C illustrates pliers being used to bend the ramp element of the posterior bite ramp of FIG. 5B to a desired angle relative to the occlusal plane;

FIG. 5D illustrates the space between the ramp elements having been filled with a curable composition;

FIG. 5E is a side view of the posterior bite ramp bonded and adjusted to a desired angle for correction of a class II malocclusion;

FIG. 5F is a side view of the posterior bite ramp bonded and adjusted to a desired angle for correction of a class III malocclusion; and

FIG. 5G is a side view of the posterior bite ramp of FIG. 5F after the upper ramp has been removed, allowing occlusal contact between the incisors.

### DETAILED DESCRIPTION OF THE PREFERRED EMBODIMENTS

### I. Introduction

The present invention is directed to posterior bite ramp devices and related kits and methods. The posterior bite ramp devices are configured for installation on upper and/or lower molars of an orthodontic patient. The bite ramp includes a substantially planar tooth-attachment element for bonding to the lingual surface of a person's molar, and at least one ramp element. The ramp element is advantageously adjustable so as to allow the practitioner to customize the devices to a desired treatment angle (i.e., between the ramp element and the occlusal plane of the molar to which the tooth-attachment element is bonded) and then lock the ramp element to the selected angle. Once installed, the ramp element provides a ramp structure at a desired angle for engaging the corresponding molar of the opposite dental arch when the person's mouth is closed. The engagement between the ramp and the corresponding molar of the opposite dental arch causes the lower jaw to move either forward or backwards relative to the upper jaw depending on the treatment ramp angle and the treatment desired.

### II. Exemplary Posterior Bite Ramps

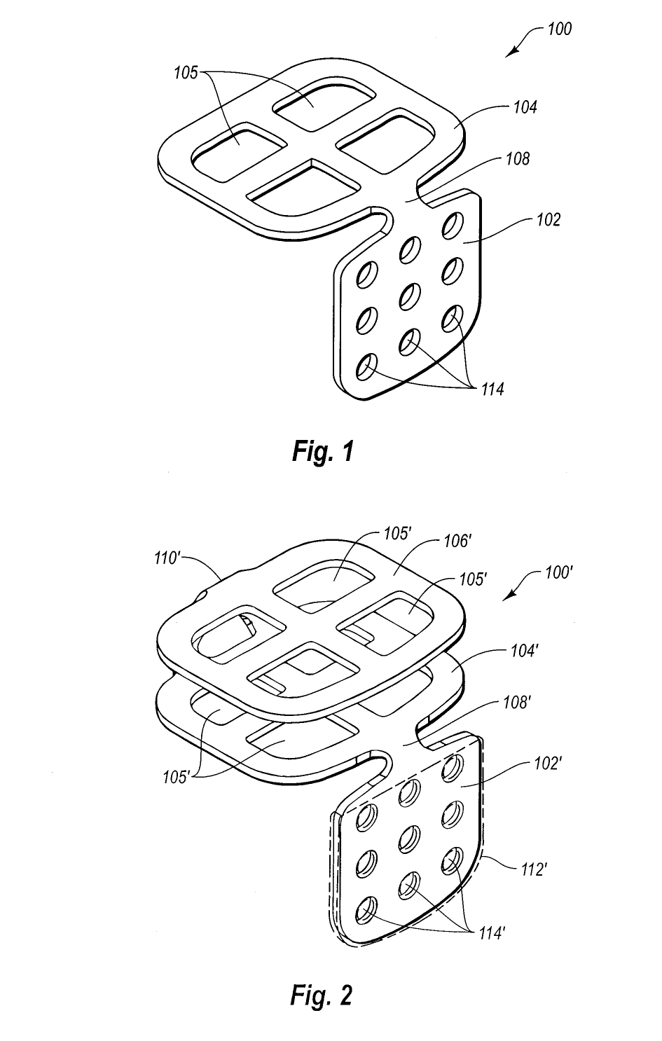

FIG. 1 illustrates an exemplary posterior bite ramp 100. Bite ramp 100 includes a tooth-attachment element 102 and a ramp element 104. Tooth-attachment element 102 is configured for bonding to the lingual surface of a person's molar (e.g., one or more upper or lower molars). Ramp element 104 is connected to tooth-attachment element 102 by means of connection web 108. Ramp element 104 is hingedly and/or bendably adjustable so as to allow the practitioner to adjust the ramp to a desired angle relative to the occlusal plane of the molar on which the device 100 is installed. Ramp element 104 is substantially planar and may include one or more discontinuities 105, which may be advantageous when applying a curable composition between the tooth-attachment element and the ramp element and/or the molar occlusal surface so as to fix ramp element 104 to a desired angle. The ramp structure formed at a desired angle engages the corresponding molar of the opposite dental arch upon closing of the person's mouth. As illustrated, tooth-attachment element 102 may further include holes or perforations 114 that aid in forming a strong bond when bonding the device to the lingual surface of a molar, as it allows the adhesive bonding resin to flow through perforations 114.

FIG. 2 illustrates another exemplary posterior bite ramp 100′. Bite ramp 100′ includes a tooth-attachment element 102′, a first ramp element 104′, and a second ramp element 106′ that is substantially parallel to first ramp element 104′. Tooth-attachment element 102′ is configured for bonding to the lingual surface of a person's molar (e.g., one or more upper or lower molars). In the illustrated embodiment, first ramp element 104′ is bendably adjustable relative to tooth-attachment element 102′ by means of connection web 108′. Second ramp element 106′ is bendably adjustable relative to first ramp element 104′ by means of a second connection web 110′. The adjustable nature of ramp elements 104′ and 106′ allows the practitioner to adjust the ramp element making contact with the corresponding opposite molar (e.g., second ramp element 106′) to a desired angle relative to the occlusal plane of the molar on which the device 100′ is installed. This occlusal plane lies generally perpendicular to the plane of tooth-attachment element 102′. The provided ramp structure engages the corresponding molar of the opposite dental arch upon closing of the person's mouth, causing movement of the lower and/or upper dental arch relative to the opposite arch as a result of the engagement with the provided ramp angle.

As illustrated, ramp elements 104′ and 106′ are substantially planar, and may include one or more discontinuities 105′, which may be advantageous when applying a curable composition between the ramp elements and/or the molar occlusal surface and/or the tooth-attachment element so as to fix the ramp elements to a desired angle.

Tooth-attachment element 102′ may optionally include a polymer cover 112′ that is overmolded over at least a portion of tooth-attachment element 102′. The tooth-attachment element 102′ may further include holes or perforations 114′ that aid in mechanically interconnecting the overmolded polymer cover 112′ over the tooth-attachment element 102′, and in bonding the tooth-attachment element to the lingual surface of a molar. Polymer cover 112′ may advantageously also cover the inside surfaces of perforations 114′, so as to not be easily slid off or otherwise removed from tooth-attachment element 102′. One purpose of the polymer cover 112′ is to provide a bonding surface that is more chemically compatible with adhesive bonding agents that may be used to adhere the tooth-attachment element 102′ to a person's tooth during use. In addition, it provides a more comfortable surface for contact with the tongue when installed. The polymer cover 112′ may optionally include undercuts on the bonding side (not shown) in order to promote better interaction and bonding between the polymer cover 112′ and an adhesive. According to one embodiment, the polymer cover 112′ and/or tooth-attachment element 102′ may be concavely curved to match the curvature of the lingual surface of a first or second molar. Although illustrated specifically in conjunction with the embodiment of FIG. 2, it will be understood that a polymer cover may be included with any of the embodiments.

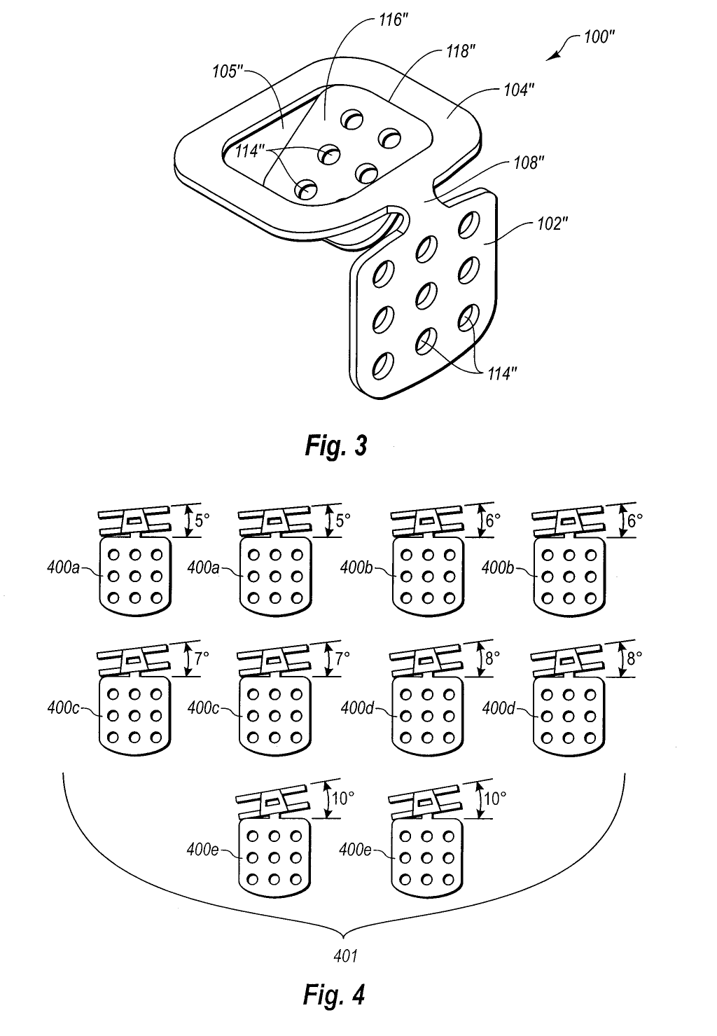

FIG. 3 illustrates an alternative embodiment of a posterior bite ramp 100″. Posterior bite ramp 100″ includes a substantially planar first tooth-attachment element 102″, a second substantially planar tooth-attachment element 116″ and a substantially planar ramp element 104″ that is connected to first tooth-attachment element 102″ by a connection web 108″. Second tooth-attachment element 116″ provides an auxiliary bonding surface for attachment to the occlusal surface of the molar to which the device is attached, which advantageously increases bond strength. Such an embodiment may be particularly advantageous when the molar's lingual surface area is relatively small or otherwise unavailable for bonding. Second tooth-attachment element 116″ is illustrated as being integrally connected to ramp element 104″ at integral interface line 118″, with tooth-attachment element 116″ extending occlusally from ramp element 104″. Ramp element 104″ also includes a discontinuity 105″ as a result of second tooth-attachment element 116″ comprising an integral part of element 104″ that has been pressed or forced in an occlusal direction. Each tooth-attachment element is illustrated as including holes or perforations 114″. Although not shown, one or both tooth-attachment elements may further include a polymer cover.

The posterior bite ramps can be made from metal, plastic, or another suitable material (e.g., a strip crown). Preferably, the material may advantageously be bendable so as to allow adjustment of the ramp structure. Suitable metals include stainless steel, titanium, and titanium alloys. Preferably any metals used are substantially nickel free or have a low nickel content (e.g., less than about 5% nickel) as to avoid patient sensitivity which can sometimes be caused by nickel. According to one embodiment, the posterior bite ramps may be injection molded from a plastic. Use of a transparent or translucent plastic material may be advantageous as it allows a light curable resin to be cured through the plastic material. The plastic material may be rigid or soft. In the case of a soft plastic material, a curable composition used to lock the ramp element in place advantageously provides sufficient rigidity so that the ramp element is able to maintain the necessary ramped surface configuration for engagement with a corresponding tooth of the opposite dental arch upon installation and during use. Examples of some suitable plastic materials include ethyl vinyl acetate (EVA), polyvinyl chloride (PVC), polycarbonates, and silicone.

### III. Exemplary Kits

The posterior bite ramps may advantageously be provided in a kit including a plurality of posterior bite ramps. In addition, in some embodiments such a kit may include a plurality of posterior bite ramps that are not adjustable, but rather include a pre-selected, fixed ramp angle. A kit of fixed posterior bite ramps may include a first fixed bite ramp having a ramp structure at a first fixed angle (e.g., 3°, configured for correction of a Class III malocclusion) and a second fixed posterior bite ramp having a ramp structure at a second fixed angle that is different from the first fixed angle. Kits may advantageously include at least two identically configured posterior bite ramps (one for each side of the dental arch).

FIG. 4 illustrates an exemplary kit including a plurality of posterior bite ramps. The illustrated kit includes a plurality of ramps similar to that illustrated in FIG. 2. Each posterior bite ramp may either be adjustable, or alternatively may be fixed at a pre-selected angle for engagement with a corresponding tooth of the opposite dental arch upon closing the patient's mouth. The kit may also include a curable composition for bonding the devices to a molar and/or locking the ramp element of adjustable posterior bite ramps at a desired treatment ramp angle.

The kit 401 of FIG. 4 includes two posterior bite ramps each of 400a, 400b, 400c, 400d, and 400e having predetermined angles of about 5°, 6°, 7°, 8°, and about 10°, respectively. The illustrated devices include angles suitable for correction of a Class III malocclusion. It will be understood that the kit and/or another kit may include opposite angles suitable for correction of a Class II maloccusion. Although not shown, each posterior bite ramp may include a marking (e.g., a character or color) identifying the fixed treatment angle. Such a marking is helpful for identification because of the generally small size of the bite ramps. Although each bite ramp is illustrated with different predetermined angles, the kit may include ramps having any desired angle (e.g., two or more having the same angle).

In the case of a kit of posterior bite ramps including pre-selected, fixed treatment ramp angles, each bite ramp within the kit includes means for locking the ramp element(s) at a fixed angle relative to an occlusal plane of the molar to which the device is to be attached. Locking means may comprise a curable resin composition applied and cured between the ramp elements and/or the tooth attachment element. Alternatively, any material (e.g., a metal weld or reinforcing member) suitable for reinforcing the fixed ramp angle may be used. In another embodiment, the posterior bite ramps may be substantially fixed by virtue of the thickness and/or material rigidity of the connection webs and ramp elements. Thus, the locking means may comprise the thickness and/or material selected for the tooth-attachment element and the ramp element. For example, the fixed angle may be established by forming the ramp elements, connection webs, and tooth-attachment element from a rigid material having a desired thickness sufficient to substantially maintain the ramp element at a fixed angle relative to the tooth attachment-element. The rigidity and thickness of the material maintains the fixed angle during orthodontic use. Kits of posterior bite ramps having ramps at various pre-selected angles allow an orthodontic practitioner to choose bite ramps having a desired angle, without having to actually make any adjustment of the ramp angle.

### IV. Exemplary Methods of Use

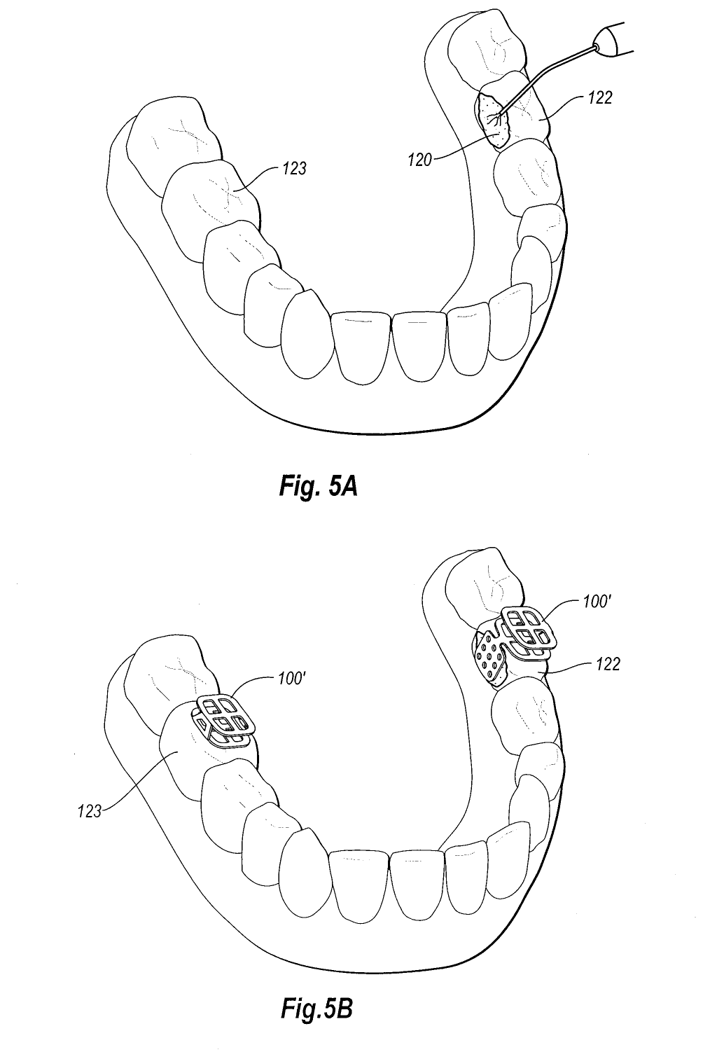

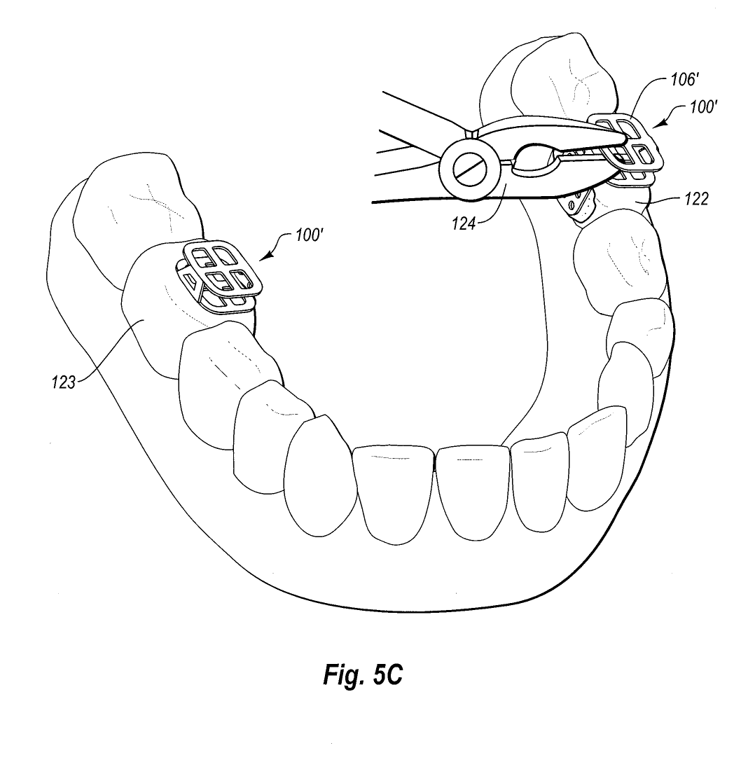

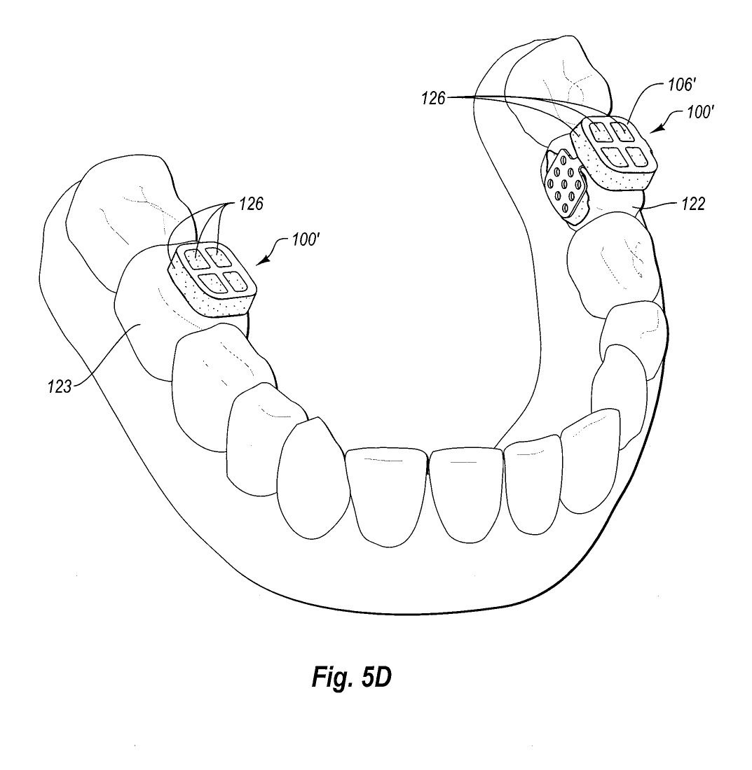

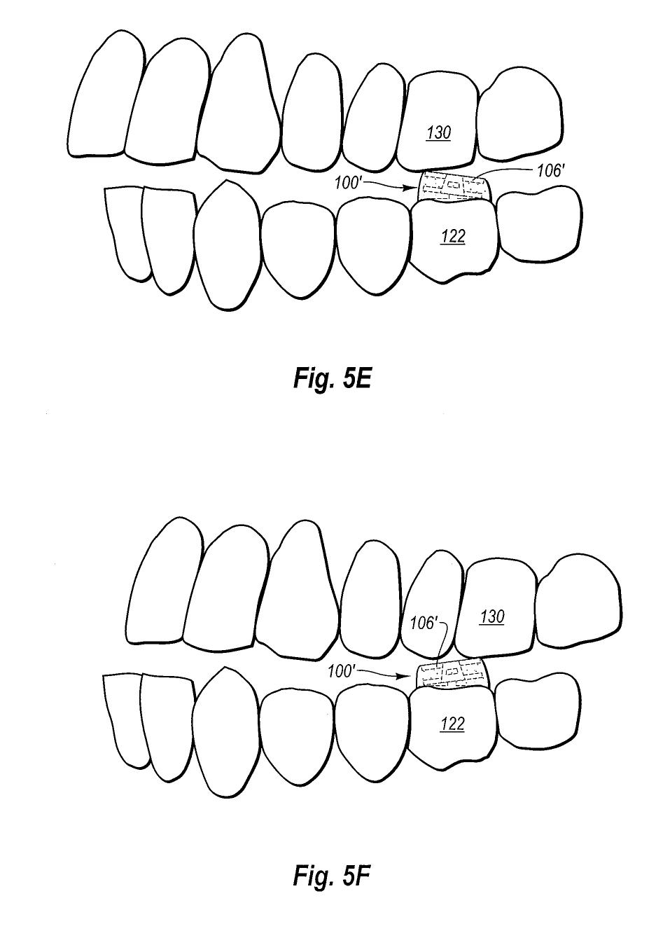

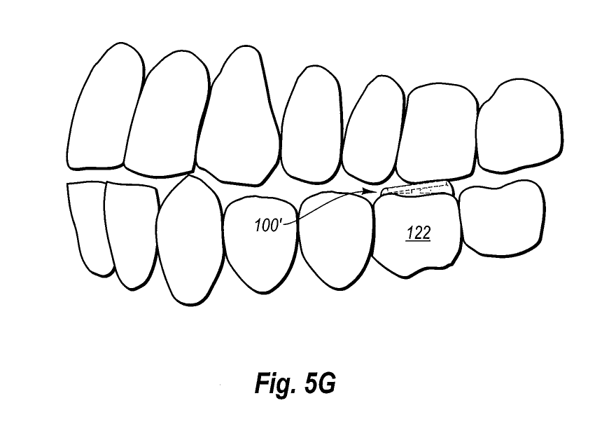

FIG. 5A illustrates application of an adhesive 120 to a prepared lingual surface of a lower first molar 122 to which a posterior bite ramp (e.g., device 100′) is to be bonded. Adhesive 120 may be any light or chemical cure adhesive resin known in the art of dentistry. As illustrated, in a typical treatment one posterior bite ramp is installed on each side of the dental arch (e.g., one device bonded to each of lower first molars 122 and 123). It will be understood that the devices may alternatively be installed on the lower second molars, or on the upper first or second molars.

As seen in FIG. 5B, the tooth-attachment element is advantageously hidden from normal view as it resides and is bonded entirely behind the person's molar. In typical use, the visibility of the device is minimized as the tooth-attachment element 102′ resides entirely on the lingual surface of the molar so as to be covered by the molar and/or the tongue, while the upper portion comprising the ramp elements 104′ and 106′ may be somewhat visible, but in typical use is rarely seen as the ramp elements are located at the posterior portion of the mouth (i.e., the ramp elements are typically hidden by the cheeks and/or lips of the patient). Being relatively inconspicuous is advantageous as many patients do not desire to draw attention to the fact that the devices are installed on their teeth. Second ramp element 106′ is adjusted (e.g., by bending) to provide a ramp structure at a desired angle, as illustrated in FIG. 5C. Although illustrated as being accomplished by use of pliers 124, any suitable tool (e.g., pliers, a probe, or even a finger) may be used to adjust the ramp angle. As shown in FIG. 5D, once ramp element 106′ has been adjusted as desired, the area between the two ramp elements 104′ and 106′ may be filled with a light or chemically curable composition 126 (e.g., a filled composite resin or routinely used cement). Composition 126 is cured and hardened so as to lock elements 104′ and 106′ into the desired adjustment angle relative to the occlusal plane defined by the occlusal surfaces of molars 122 and 123. Curable composition 126 is an example of means for locking a ramp element in a desired ramp configuration.

In a typical treatment, posterior bite ramps are installed on opposite sides of the dental arch and with the same adjustment angles (i.e., the ramp element on molar 122 is adjusted to the same angle as the ramp element on molar 123) so as to dissocclude both sides of the dental arch evenly and effect movement and correction by causing the upper and/or lower dental arch to slide forward or backward.

As illustrated in FIG. 5E, ramp element 106′ may be adjusted and fixed to an angle suitable for correcting a Class II malocclusion (i.e., the lower jaw needs to move forward relative to the upper jaw). FIG. 5F illustrates an alternative example where the ramp element 106′ is adjusted and fixed to an angle suitable for correction of a Class III malocclusion (i.e., the lower jaw needs to move backwards relative to the upper jaw). As seen in FIGS. 5E and 5F, the ramp element 106′ engages a corresponding molar of the opposite dental arch (e.g., the upper first molar 130). As the person's mouth is closed, the engagement between ramp element 106′ and corresponding upper first molar 130 causes a disocclusion of the dental arches except at a point of contact between the ramp element and the corresponding molar. In addition, when the person's mouth is closed, a force is applied as a result of the interaction between corresponding molar 130 and ramp element 106′, which causes the person's lower jaw to move either forward or backward relative to the upper jaw so as to correct the Class II or Class III malocclusion.

The ramp element 106′ may be adjusted (e.g., as illustrated in FIG. 5C) so as to provide a ramp structure at any desired angle. The angle is defined between the ramp element 106′ and the substantially horizontal occlusal plane of the tooth to which the device is installed. Typical angles range from about 1° to about 20°, more typically between about 2° and about 15°, and more typically between about 5° degrees and about 10°. The exact angle between ramp element 106′ and the occlusal plane will depend on one or more of the relative positions of the upper and lower jaws (i.e., the degree of correction required), the size of a person's teeth, other simultaneous treatments being performed, and the like.

In one embodiment, the posterior bite ramps may advantageously be used with orthodontic brackets and an arch wire to correct other malocclusion issues, for simultaneous treatment. Such simultaneous treatment significantly reduces overall treatment times, as several orthodontic issues may be addressed at once.

The posterior bite ramp 100′ of FIG. 2 advantageously initially includes first and second ramp elements 104′ and 106′. At the start of treatment, ramp element 106′ is used to contact the corresponding tooth of the opposite dental arch. As treatment progresses, ramp element 106′ may be removed (e.g., by cutting away both ramp element 106′ and surrounding portions of composition 126), and the surfaces surrounding ramp element 104′ may be resmoothed by applying and curing additional curable composition 126. As shown in FIG. 5G, thereafter, engagement is between corresponding molar 130 and ramp element 104′, which allows the patient's jaw to assume a configuration having a smaller disocclusion (i.e., the disocclusion height is lower and/or less teeth are disoccluded), which is more comfortable for the patient.

The plurality of ramp elements (i.e., 104′ and 106′) provides a degree of flexibility for the endodontic practitioner and patient as the upper ramp 106′ may be used during the early stages of treatment when a more complete disocclusion is advantageous as it speeds treatment progress. Then, after some correction of patient malocclusion has been achieved, ramp element 106′ may be removed and treatment may continue with first ramp element 104′. If ramp elements 106′ and 104′ were adjusted together (i.e., by bending connection web 108′), then ramp element 104′ already includes the same adjustment angle as selected for ramp element 106′ because of the generally parallel configuration of ramp elements 104′ and 106′. The practitioner may make any adjustments or changes to the treatment ramp angle at this stage, if desired. Once ramp element 106′ is removed, the degree of disocclusion of the upper jaw from the lower jaw is greatly reduced, such that the incisors and/or canines may make occlusal contact and where only the posterior teeth (e.g., the bicuspids and molars) remain disoccluded, and to a lower degree than before (i.e., the distance between occlusal surfaces of corresponding teeth is reduced as compared to the configuration of FIG. 5F). Such a configuration is much more comfortable for the patient, and still allows for a sufficient degree of disocclusion (as it may be near the end of treatment) so as to complete the treatment.

The present invention may be embodied in other specific forms without departing from its spirit or essential characteristics. For example, it may be desirable to use the adjustable bite ramps in treating medical joint problems. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A posterior bite ramp for use in an orthodontic treatment to correct a class II or a class III malocclusion, comprising:
a substantially planar tooth-attachment element for bonding to the lingual surface of a person's molar; and
a ramp element comprising a substantially planar surface that is defined by and entirely enclosed by a continuous perimeter that continuously extends around the ramp element along the planar surface, the continuous perimeter further enclosing and at least partially defining at least one hole in the planar surface of the ramp element that passes entirely through the surface of the ramp element and in a substantially orthogonal direction to the substantially planar surface of the ramp element, the ramp element being attached to the tooth-attachment element by a connection web;
the connection web being hingedly and/or bendably adjustable so as to allow adjustment to a desired angle between the ramp element and an occlusal plane that is substantially perpendicular to the tooth attachment element, the ramp element providing an angled ramp structure for engagement with a corresponding molar of an opposite dental arch so as to disocclude a patient's molars upon closing a patient's mouth.

2. A posterior bite ramp as recited in claim 1, wherein the tooth-attachment element includes holes or perforations formed therein.

3. A posterior bite ramp as recited in claim 2, further comprising a polymer cover overmolded over at least a portion of the tooth-attachment element.

4. A posterior bite ramp as recited in claim 1, wherein the tooth-attachment element has a concave curvature corresponding to a curvature of the lingual surface of a person's molar.

5. A posterior bite ramp as recited in claim 1, further comprising means for locking the connection web and ramp element in a desired adjustment angle relative to an occlusal plane that is substantially perpendicular to the tooth attachment element.

6. A posterior bite ramp as recited in claim 5, wherein the means for locking comprises a curable composition that is applied to and cured between the tooth-attachment element and a second ramp element.

7. A posterior bite ramp as recited in claim 1, wherein the tooth-attachment element, the ramp element, and the connection web comprise a single integral piece.

8. A posterior bite ramp as recited in claim 1, wherein the tooth-attachment element, the ramp element, and the connection web are formed from one of stainless steel, titanium, or a titanium alloy.

9. A posterior bite ramp as recited in claim 1, wherein the tooth-attachment element is sized and configured for bonding entirely behind a person's molar to the lingual surface thereof.

10. A posterior bite ramp as recited in claim 1, further comprising a second ramp element attached to the first ramp element by a second connection web, the two ramp elements being spaced apart and substantially parallel to one another.

11. A posterior bite ramp as recited in claim 1, further comprising a second tooth-attachment element for bonding to the occlusal surface of a person's molar, the second tooth-attachment element being integrally connected to the ramp element, the second tooth-attachment element extending occlusally from the ramp element.

12. A posterior bite ramp for use in an orthodontic treatment to correct a class II or a class III malocclusion, comprising:
a substantially planar tooth-attachment element for bonding to the lingual surface of a person's molar; and
a first ramp element attached to the tooth-attachment element by a first connection web;
a second ramp element attached to the first ramp element by a second connection web, wherein the second ramp element is stacked in a relative placement above the first ramp element and such that the first ramp element is positioned relatively between the second ramp element and the tooth-attachment element; and
at least one of the first or second connection webs being hingedly and/or bendably adjustable so as to allow adjustment to a desired angle between at least one of the ramp elements and an occlusal plane that is substantially perpendicular to the tooth attachment element, at least one of the ramp elements providing an angled ramp structure for engagement with a corresponding molar of an opposite dental arch so as to dissocclude a patient's molars upon closing a patient's mouth.

13. (canceled)

14. A kit for use in an orthodontic treatment to correct a class II or a class III malocclusion, comprising:
a curable composition; and
a plurality of posterior bite ramps, each posterior bite ramp including:
a substantially planar tooth-attachment element for bonding to the lingual surface of a person's molar; and
a substantially planar ramp element attached to the first tooth-attachment element by a connection web, the ramp element comprising a substantially planar surface that is defined by and entirely enclosed by a continuous perimeter that continuously extends around the ramp element along the planar surface, the continuous perimeter further enclosing and at least partially defining at least one hole in the planar surface of the ramp element that passes entirely through the surface of the ramp element and in a substantially orthogonal direction to the substantially planar surface of the ramp element, the ramp element being;
the connection web being either:
fixed so as to form a fixed angle between the ramp element and an occlusal plane that is substantially perpendicular to the tooth attachment element, or
hingedly and/or bendably adjustable so as to allow adjustment to a desired angle between the ramp element and an occlusal plane that is substantially perpendicular to the tooth attachment element, the ramp element providing an angled ramp structure for engagement with a corresponding molar of an opposite dental arch so as to disocclude a patient's molars upon closing a patient's mouth; and
wherein the kit includes a first posterior bite ramp having an angled ramp structure fixed at a first angle and a second posterior bite ramp having an angled ramp structure fixed at a second angle, the second angle being different from the first angle.

15. A kit as recited in claim 13, wherein the curable composition comprises an adhesive resin for adhesively attaching the plurality of posterior bite ramps to a patient's molars.

16. A kit as recited in claim 13, wherein each of the plurality of posterior bite ramps are fixed so as to form a fixed angle between the ramp element and an occlusal plane that is substantially perpendicular to the tooth attachment element.

17. (canceled)

18. A method of orthodontic treatment for correcting a class II or class III malocclusion, comprising:
selecting one or more posterior bite ramps from the kit recited in claim 14; and
bonding the tooth-attachment element of the posterior bite ramp to the lingual surface of a molar with the curable composition so as to form an angle between the ramp element and an occlusal plane of the molar to which the tooth-attachment element is bonded.

19. A method as recited in claim 17, further comprising adjusting the ramp element of the posterior bite ramp to have a desired ramp angle for engagement with a corresponding molar of the opposite dental arch upon closing the patient's mouth and locking the ramp element to the desired ramp angle.

20. A method as recited in claim 17, wherein the one or more selected bite ramps are fixed angle bite ramps, the selected posterior bite ramps having a desired ramp angle for engagement with a corresponding molar of the opposite dental arch upon closing the patient's mouth.

21. A method as recited in claim 17, wherein the ramp element forms an angle between the ramp element and an occlusal plane of the molar to which the tooth-attachment element is bonded that is between about 1° and about 20°.

22. A method as recited in claim 17, wherein the ramp element forms an angle between the ramp element and an occlusal plane of the molar to which the tooth-attachment element is bonded that is between about 2° and about 15°.

23. A method as recited in claim 17, wherein the ramp element forms an angle between the ramp element and an occlusal plane of the molar to which the tooth-attachment element is bonded that is between about 5° and about 10°.

24. A method as recited in claim 17, wherein the selected posterior bite ramps each comprise first and second ramp elements, further comprising removing the second ramp elements during treatment.

25. A as recited in claim 12, wherein the second ramp element comprises a substantially similar shape and size as a shape and size of the first ramp element.
